(19) United States
(12) Patent Application Publication
(10) Pub. No.: US 2010/0171371 A1
(43) Pub. Date: Jul. 8, 2010

(54) Wireless Electric Power Transmission Device

(75) Inventors: Vitalii Grigorovich Kriuk, Kyiv (UA); Vitalii Anatoliiovych Iatsyshyn, Kyiv (UA); Mykola Mykolaiovych Beldii, Kyiv (UA)

Correspondence Address: Aleksandr Smushkovich, P.O. Nox 140505, Brooklyn, NY, 11214, US

(73) Assignee: NXP B.V., Eindhoven (NL)

(21) Appl. No.: 12/733,200

(22) PCT Filed: Jul. 17, 2008
(86) PCT No.: PCT/UA2008/000044

§ 371 Date: Feb. 17, 2010

(30) Foreign Application Priority Data
Aug. 20, 2007 (UA) A 2007 09441

(51) Int. Cl. H02J 17/00

(52) U.S. Cl. 307/104

(57) ABSTRACT

The novelty of the invention consists in that it makes possible to improve the known device having the same purpose (UA Nr 78002) by the novel design of the transmitter and receiver antennas and the circuits for connecting them to an electric power generator and a load resistor. The invention discloses the experiment for transmitting power of 10 W at a distance of 1.8 m with an output ratio of ≈1 which proves the industrial applicability of the invention.

### CROSS-REFERENCE TO RELATED APPLICATIONS

This application is a U.S. national phase application of a PCT application PCT/UA2008/000044 filed on 17 Jul. 2008 with a claims amendment filed on 23 Dec. 2008, published as WO2009/025631, whose disclosure is incorporated herein in its entirety by reference, which PCT application claims priority of a Ukrainian patent application: UA a2007/09441 filed on 20 Aug. 2007.

### FIELD OF THE INVENTION

The invention relates to the field of electrical and radio engineering and can be applied in electric power industry; particularly it can replace expensive power transmission lines.

### BACKGROUND OF THE INVENTION

The invention solves the following problems:

a) Overcoming natural barriers (rivers, mountains, etc.) on the way of power transmission lines.
b) Wireless power supply of residential or industrial buildings, vehicles, lighting devices, etc.

Known is a wireless electric power transmission device (EPTD) (see Kriuk V. G., Iatsyshyn V. A, Beldii M. M. “Wireless electric power transmission device”. Patent UA N. 78002, Bulletin No. 2, 2007) schematically represented on FIG. 1 of the present disclosure.

The aforementioned device comprises a transmitter (emitter) of electric power which includes coils 1 and 2 of the right- and left-handed windings, connected serially with each other, a generator of electric power 3, a receiver (collector) of electric power which includes coils 4 and 5 from the right- and left-handed windings, connected in parallel with each other and resistance of loading 6; coils 1, 2 and 4, 5 have the shape of semi-pseudo-spheres that function as transmitting and receiving antennas in the form of pseudo-spheres.

In the mentioned EPTD, the transmitting antenna is provided in the shape of a pseudo-sphere and can be identified as an electric half-wave (λ/2) vibrator and the receiving antenna can be identified as a magnetic half-wave (λ/2) vibrator. Thus, the noted identifications are based on experimentally investigated rectilinear antennas with ferrite cores and the same type of connection between the coils and the generator of electric power and resistance of loading, as used in the mentioned Patent UA No. 78002. It was theoretically expected that in the EPTD, combinations of the well-known electric and magnetic antennas (vibrators) (Meinhe H., Gundlakh F. V. “Radiotechnical reference book”, Vol. 1, M-L, “Gosenergoizdat”, 1961) and their not ordinary pseudo-spherical shape, would provide a resonance electromagnetic coupling (K_{EH}) between the transferring and receiving antennas EPTD close to 1 (K_{EH}≈1) and thereby would provide an electric power transfer through the free space (without wires) with an efficiency factor (EF≈1) close to 1. Those expectations however did not come true.

Thus, the basic drawbacks of the aforementioned EPTD are its inoperativeness and industrial inapplicability.

The problem to be solved by the present invention is to improve the known EPTD, by means of providing a novel device with transmitting and receiving antennas and new schemes of their connection with an electric power generator and an electric load resistor that would allow providing a resonance electromagnetic coupling of the transmitting and receiving antennas close to 1 (K_{EH}≈1) and thereby providing a wireless electric power transfer from the electric power generator to the load resistor with an efficiency close to 1 (EF≈1).

Herein, the problem has been solved by providing an inventive electric power transmitting device (also further called an ‘EPTD’), which device generally comprises: a transmitter, including a transmitting antenna having a semi-pseudo-spherical shape with winding wound thereon, an electric power generator, and a transmitter grounding; a receiver, including a receiving antenna having a semi-pseudo-spherical shape with winding wound thereon, an electric load, and a receiver grounding; wherein the transmitting antenna is serially electrically connected with the generator and the transmitter grounding, and the receiving antenna is serially electrically connected with the electric load and the receiver grounding. In some inventive embodiments, the transmitter grounding and the receiver grounding are represented by a common grounding.

### BRIEF DESCRIPTION OF DRAWINGS

FIG. 1 shows a prior art device according to Ukrainian Patent UA78002.

FIG. 2 schematically shows an electric power transmission device (EPTD) according to an embodiment of the present invention.

FIG. 3 shows an exemplary geometrical shape of a pseudo-sphere with parallels and meridians.

FIG. 4 shows an exemplary curve of tractrix that forms a pseudo-sphere.

FIGS. 5a and 5b schematically shows an artificial electromagnetic field and a natural electromagnetic field, which fields interact in the EPTD.

FIG. 6 illustrates voltages and electric currents in the transmitter and receiver of the EPTD, according to an embodiment of the present invention.

FIG. 7 schematically shows the EPTD that has experimentally carried out a wireless transfer of electric power with K_{EH}≈1, according to an embodiment of the present invention.

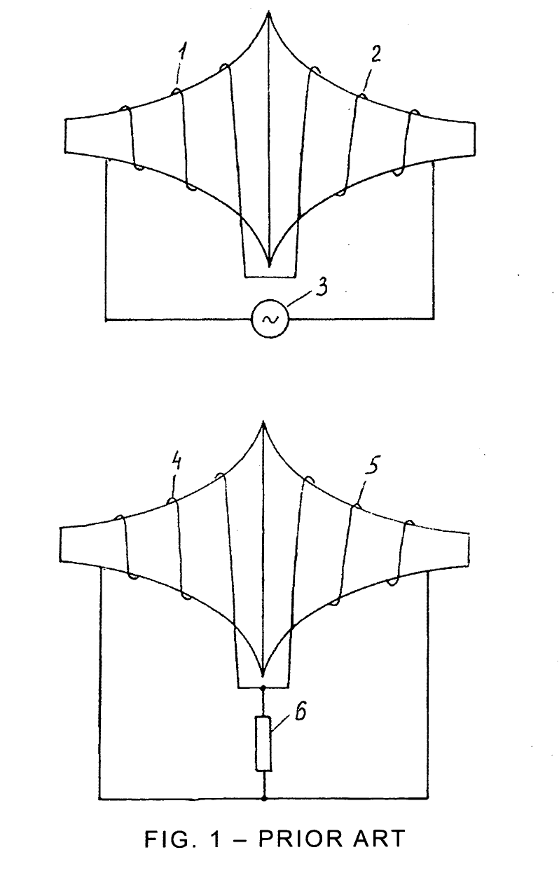

### DETAIL DESCRIPTION OF PREFERRED EMBODIMENTS OF THE INVENTION

While the invention may be susceptible to embodiment in different forms, there are described in detail herein below, specific embodiments of the present invention, with the understanding that the present disclosure is to be considered an exemplification of the principles of the invention, and is not intended to limit the invention to that as illustrated and described herein.

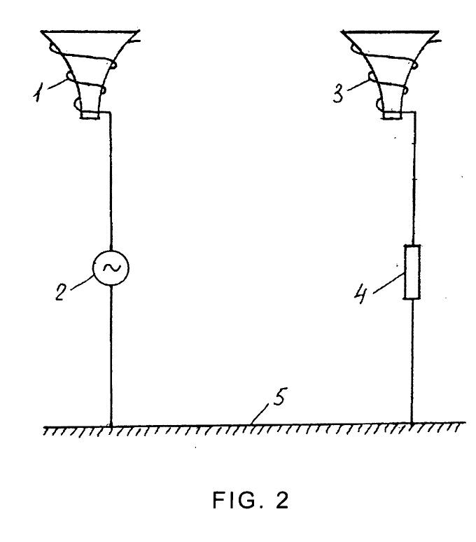

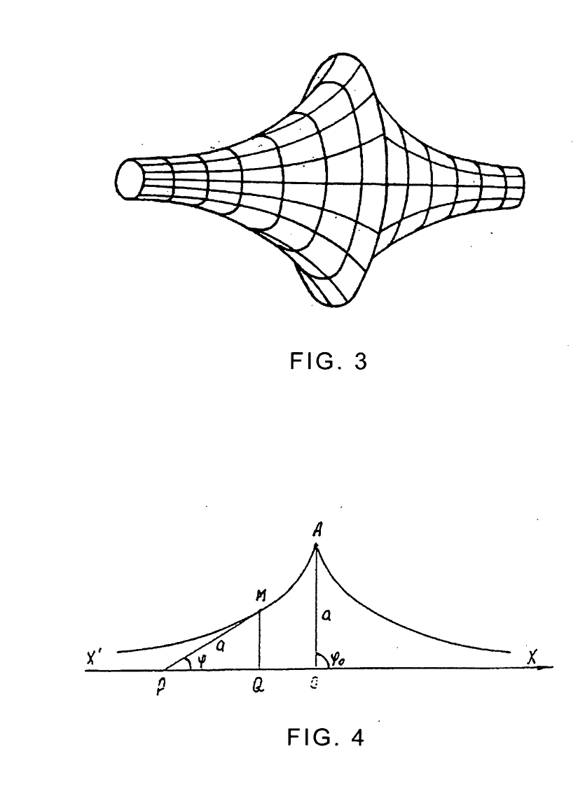

Referring to FIG. 2, in a preferred embodiment, the inventive wireless EPTD comprises: (a) an electric power transmitter, including: a transmitting antenna 1 having a semi-pseudo-spherical shape (a pseudo-sphere is illustrated in FIG. 3, and its formation is depicted on FIG. 4) with a coil wound thereon, an electric power generator 2, serially connected with the antenna 1, and a grounding 5, serially connected with the generator 2; and (b) an electric power receiver, including: a receiving antenna 3 having a semi-pseudo-spherical shape with a coil wound thereon, an electric load resistor 4 serially connected with the antenna 3, and the resistor 4 serially connected with the grounding 5.

### OPERATION OF A PREFERRED EMBODIMENT OF THE INVENTION

As mentioned above and illustrated on FIG. 3, in a preferred embodiment of the inventive EPTD, the transmitting and receiving antennas are shaped as semi-pseudo-spheres, i.e. halves of a pseudo-sphere, which is a geometrical body formed by rotation of a tractrix around an asymptote X′X shown on FIG. 4. A tractrix is defined as a geometrical place of points drawn by a first end a of a straight segment line, while a second end of the segment line moves along a straight line X′X. AO=a is a height of the tractrix (φ=90°); M—is a contact point of a segment MP=a (φ<90°) to the tractrix (Vigodskiy M. Ya. “Calculus reference book”, M., “Nauka”, 1963, p. 822).

It is essential that the pseudo-sphere, being an infinitely longitudinally extended geometrical body along the asymptote X′X, has a finite area of a surface (Sₚ) equal to an area of a surface (Sₛ) of a sphere with a radius r=a and a finite volume (Vₚ) equal to a half of volume of this sphere (Vₛ/2), that is:

$$\begin{matrix}{S}_{p} = {S}_{s} = 4 π {a}^{2} = 4 π {r}^{2} & ( 1 ) \\ {V}_{p} = \frac{1}{2} {V}_{s} = \frac{2}{3} π {a}^{3} = \frac{1}{2} ( \frac{4}{3} π {r}^{3} ) & ( 2 )\end{matrix}$$

(Vigodskiy M. Ya. “Calculus reference book”, M., “Nauka”, 1963, p. 827).

It is known that the radiation power of electromagnetic energy (P) through a confined surface during a period of time unit is defined by the following formula:

$$\vec{P} = {∮}_{S} \vec{W} d \vec{S} = {∮}_{S} [ \vec{E} \vec{H} ] d \vec{S} , \qquad ( 3 )$$

wherein:
\vec{W}=[\vec{E} \vec{H}]—is a vector of volume density of an electromagnetic energy flow, also called a Pointing Vector;
d\vec{S}—is an element of area S of the confined surface (Katushev A. M. Golubeva N. S. ‘Basics of Radioelectronics, M., “Energiya”, 1969, page 101);

Taking into consideration that:

$$E = \frac{H}{120 π}$$

considering that 120π=377 Ohm-wave resistance of the free space, and also for a sphere:

$${∮}_{S} dS = 4 π {r}^{2} ,$$

Based on the formula (3), one can obtain:

$$E = \frac{\sqrt{30 P}}{r} \qquad ( 4 )$$

(Katushev A. M. Golubeva N. S. ‘Basics of Radioelectronics, M., “Energiya”, 1969, page 102).
The formula (4) is the basis for calculations of intensity of an electric field E in radio communication practice at values set for P and r.

Taking into account the equality (1), the formula (4) is valid for a surface both in the form of sphere, and in the form of a pseudo-sphere.

$$P = {∮}_{S = {S}_{s} = {S}_{p}} [ \vec{E} \vec{H} ] dS \\ = {\int }_{{V}_{s}} div [ \vec{E} \vec{H} ] d {V}_{s} \\ = 2 {\int }_{{V}_{p}} div [ \vec{E} \vec{H} ] d {V}_{p} \begin{matrix}\neq 0 , \\ = 0.\end{matrix} \qquad ( 5 )$$

But, there are new possibilities when, according to the theorem of Ostrogradsky-Gauss, the dependence (3) tied together with the volumes (2), that is the dependence (5) is considered in two variants:

1) the parts of dependence (5) are not equal to zero, thus they characterize an energetically open system (the result (4) is a consequence of it);

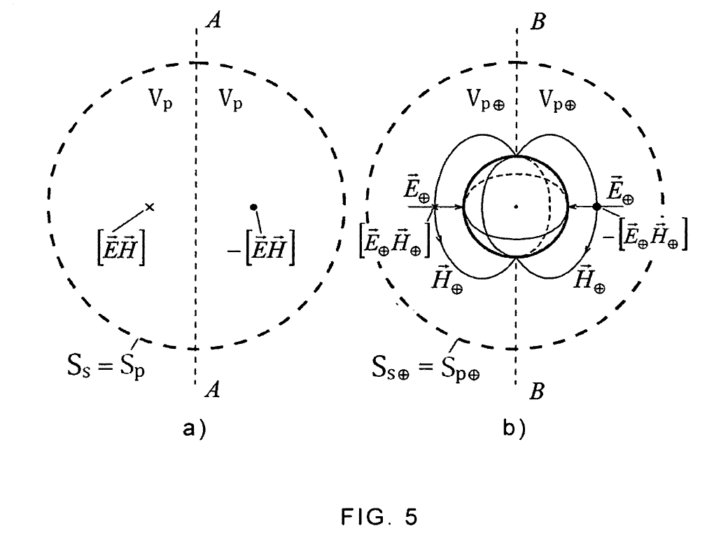

2) the parts of dependence (5) are equal to zero, thus the part which is connected with pseudo-sphere volumes, can characterize an energetically closed (isolated) system, processes in which are defined by the following equality:

$${\int }_{{V}_{p}} div [ \vec{E} \vec{H} ] d {V}_{p} {\vert}_{1 / 2 S} = - {\int }_{{V}_{p}} div [ \vec{E} \vec{H} ] d {V}_{p} {\vert}_{1 / 2 S} \qquad ( 6 )$$

wherein a half of area S=S_{S}=Sₚ are marked by the index (½ S). This area contains two volumes Vₚ within volume Vₛ accordingly from (1) and (2) (FIG. 5a).

The equality (6) describes an internal resonant balance of electromagnetic energy in the closed system with a volume Vₛ; in this system two streams of electromagnetic energy move towards each other [Sivuhin D. V, “General Physics Course”, Vol. III, M., “Nauka”, 1977, p. 627]. Just in such system, the equality K_{EH}=1 between the incident and the reflected electromagnetic energy flows is possible.

According to the inventive embodiment shown on FIG. 2, the transmitting and receiving antennas are semi-pseudo-spheres, rather than pseudo-spheres, as taught in the mentioned Patent UA 78002. Therefore, in the equality (6), the numerical factors should be divided by, that is:

$$\frac{1}{2} {\int }_{{V}_{p}} div [ \vec{E} \vec{H} ] d {V}_{p} {\vert}_{1 / 4 S} \neq - \frac{1}{2} {\int }_{{V}_{p}} div [ \vec{E} \vec{H} ] d {V}_{p} {\vert}_{1 / 4 S} \qquad ( 7 )$$

Wherein the sign of inequality ‘≠’ testifies that the transmitter-receiver system thus became energetically open and, as a consequence, in such system K_{EH}≠1.

This fact stimulates a search of an electromagnetic intermediary, which would energetically confine the space between the EPTD transferring and reception antennas. Undoubtedly, the electric and magnetic fields of the Earth serve as such intermediaries.

They exist between the EPTD transmitting and receiving antennas. These fields-intermediaries are schematically represented on FIG. 5b, wherein three intermediary fields are shown, with marked volumes and areas of the pseudo-spheres correlating with the volume and spherical area around the Earth. The fields form an energetically confined system.

Considering another source (Kriuk V. G., “Natural system of units on the base of units of natural time”, Kiev, “Hagar”, 2001), in dynamics, electric and magnetic fields of the Earth are represented (similarly to the formula (6)) by an equality:

$${\int }_{{V}_{p ⊕}} div [ {\vec{E}}_{⊕} {\vec{H}}_{⊕} ] d {V}_{p ⊕} {\vert}_{1 / 2 S ⊕} = - {\int }_{{V}_{p ⊕}} div [ {\vec{E}}_{⊕} {\vec{H}}_{⊕} ] d {V}_{p ⊕} {\vert}_{1 / 2 S ⊕} \qquad ( 8 )$$

For the next step, the following two factors should be noted:

First factor. It is known that volume differentiation of quantities describes their condition in a point (in a micro-volume) of space (Bronshtein N. N., Semendyaev K. A. “Mathematics reference book”, M., “Nauka”, 1964, p. 541).

It concerns also the divergence (source) of electromagnetic energy of the parts of the inequality (7), which divergence is accompanied by a vortex (rot) of electric and magnetic fields, that is:

div[\vec{E}\vec{H}]=\vec{H}rot\vec{E}−\vec{E}rot\vec{H} (9)

The equality (9) describes a condition of electromagnetic waves (quantum) with a length from x-ray to infra-red (i.e. from micro-waves), which are capable to ionize molecules and atoms of an environment and, as a consequence, to show actions of electric and magnetic fields of the Earth (Sivuhin D. V, “General Physics Course”, Vol. III, M., “Nauka”, 1977 p. 86), to super-long waves (i.e. mega-waves).

It concerns also the parts of the equations (8); particularly those parts which describe a condition of the electromagnetic waves (quantum) connected with the Earth.

Second factor. Undoubtedly that, under any circumstances, the EPTD's transmitting and receiving antennas are located on one side of the Earth.

The first factor confirms the interaction between the parts of inequality (7) and the equality (8), the second factor confirms the interaction between the parts of inequality (7). These parts can be only one component (half) of the equality (8), which is thus divided into two parts between the components parts of inequality (7). As a result, considering the noted two factors, on the basis of (7) and (8), the following equality can be composed:

$$\frac{1}{2} {\int }_{{V}_{p}} div [ \vec{E} \vec{H} ] d {V}_{p} {\vert}_{1 / 4 S} - \frac{1}{2} {\int }_{{V}_{p ⊕}} div [ {\vec{E}}_{⊕} {\vec{H}}_{⊕} ] d {V}_{p ⊕} {\vert}_{1 / 4 S ⊕} == \frac{1}{2} {\int }_{{V}_{p ⊕}} div [ {\vec{E}}_{⊕} {\vec{H}}_{⊕} ] d {V}_{p ⊕} {\vert}_{1 / 4 S ⊕} - \frac{1}{2} {\int }_{{V}_{p}} div [ \vec{E} \vec{H} ] d {V}_{p} {\vert}_{1 / 4 S} \qquad ( 10 )$$

and considering:

$$\frac{1}{2} {V}_{p} = \frac{1}{4} {V}_{s} ,$$

and according to the dependence (2), it leads to:

$$\frac{1}{4} {\int }_{{V}_{s}} div [ \vec{E} \vec{H} ] d {V}_{s} {\vert}_{1 / 4 S} - \frac{1}{4 } {\int }_{{V}_{s ⊕}} div [ {\vec{E}}_{⊕} {\vec{H}}_{⊕} ] d {V}_{s ⊕} {\vert}_{1 / 4 S ⊕} == \frac{1}{4 } {\int }_{{V}_{s ⊕}} div [ {\vec{E}}_{⊕} {\vec{H}}_{⊕} ] d {V}_{s ⊕} {\vert}_{1 / 4 S ⊕} - \frac{1}{4} {\int }_{{V}_{s}} div [ \vec{E} \vec{H} ] d {V}_{s} {\vert}_{1 / 4 S} \qquad ( 11 )$$

The equality (10) and its equivalent (11) describe an energy-confined system, since as the left and the right parts are, according to (1) and (2), halves of the volumes of a sphere which are limited by the halves of areas of the sphere. It affirms that between the halves of such system there is an electromagnetic coupling with a factor K_{EH}=1 and a transmission of energy with EF≈1 is possible.

Indeed, in this closed system, there is exists an artificially created (div└\vec{E}\vec{H}┘) and a natural flows of electromagnetic energy, which, on a joint of the left and right parts of equality (11), are in a resonant balance. And this resonant balance will not be broken also if an energy source is introduced into the left part of equality (11), and this energy is deduced (utilized) from the right part.

This occurs in the EPTD: —an energy (div└\vec{E}\vec{H}┘) is introduced from the generator 2 through the antenna 1 into the energetically confined system (11), and this energy is deduced through the antenna 3 into the load resistor 4; thus, the energy (div└\vec{E}_{⊕}\vec{H}_{⊕}┘) is only a carrier of energy (div└\vec{E}\vec{H}┘).

The energy per a time unit from the generator 2 is defined by a power:

P_{g}=U_{g}I_{g},

and the energy consumed by the load resistor 4 is defined by a power:

Pₕ=UₕIₕ,

that transforms the equation (11) into:

$${P}_{g} = {U}_{g} {I}_{g} -> \frac{1}{4} {\int }_{{V}_{s}} div [ \vec{E} \vec{H} ] d {V}_{s} {\vert}_{1 / 4 S} - \frac{1}{4 } {\int }_{{V}_{s ⊕}} div [ {\vec{E}}_{⊕} {\vec{H}}_{⊕} ] d {V}_{s ⊕} {\vert}_{1 / 4 S ⊕} == \frac{1}{4 } {\int }_{{V}_{s ⊕}} div [ {\vec{E}}_{⊕} {\vec{H}}_{⊕} ] d {V}_{s ⊕} {\vert}_{1 / 4 S ⊕} - \frac{1}{4} {\int }_{{V}_{s}} div [ \vec{E} \vec{H} ] d {V}_{s} {\vert}_{1 / 4 S} -> {P}_{h} = {U}_{h} {I}_{h} \qquad ( 12 )$$

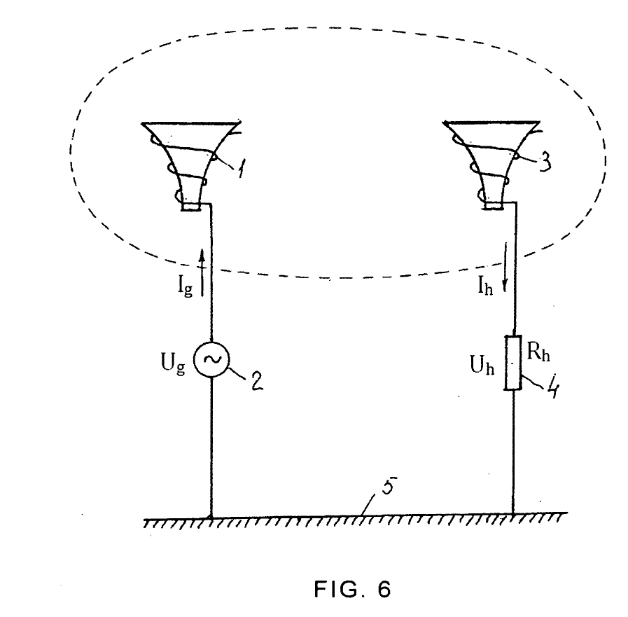

and is illustrated on FIG. 6.

In a resonant system, which is described by dependence (12) a losses of energy are extremely small; as resistance of radiation of antennas and wave resistance of a communication channel between antennas are functions of spatial characteristics of antennas, length of a wave and the environment (vacuum), i.e. are not active (Meinhe H., Gundlakh F. V. “Radiotechnical reference book”, Vol. 1, M-L, “Gosenergoizdat”, 1961). It is experimentally proven that the Efficiency Factor (EF)=

$$\frac{{P}_{h}}{{P}_{g}} \approx 1$$

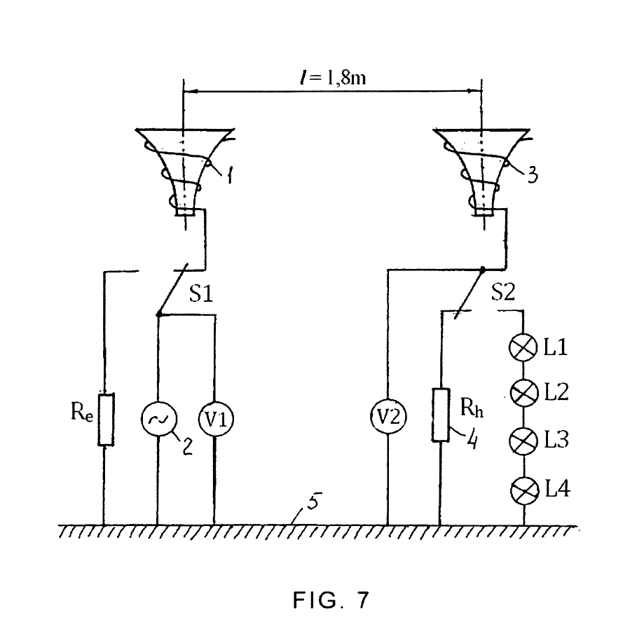

An embodiment of the inventive wireless electric power transmission device is schematically represented on FIG. 7. The antennas 1 and 3 are identical and possess the following parameters: a=10 cm, x₁=a=10 cm (FIG. 4), number of turns=375 of wire (PELShO-0.23). Each of these antennas, as have shown by measurements, has an inductance L≈11 milli-Henry and a resonance frequency=600 kHz (λ=500 m); calculated on the basis of the formula:

$$f = \frac{1}{2 π \sqrt{LC}}$$

and its own (“parasitic” or geometrical) capacitance=5 Pico-Farad. The distance between the antennas 1 and 3 has a size l=1.8 m (the size l is pre-calculated); voltmeters V1 and V2 measure voltages on an output of the generator 2 (U_{g}) and on the load resistor 4 (Uₕ); a switch π1 allows connecting the generator 2 either to the antenna 1, or to an equivalent resistance of Rₑ, and a switch π2 that allows connecting the antenna 3 either to the load resistor 4, or, for the purpose of visual demonstration, to four filament lamps L1-L4, 26V 0.12A (power consumption P=4×26×0.12=12.48 Wt).

Measurements have shown that the generator 2 is loaded equally in a mode of wireless transfer of electric power (switches S1 and S2 are in a position shown on FIG. 7), and in a mode of operation with the equivalent resistance Rₑ (switch S1 in position of connection of Rₑ).

### Since

Rₑ=Rₕ=1000 Ohm

it testifies for the equality of currents:

I_{g}=Iₕ=Iₑ

and voltages:

U_{g}=U_{H}=Uₑ=100 V

Results of experiments testify an approximate equality of the generator and load powers:

P_{g}=U_{g}I_{g}=(U_{g})²/Rₑ=Pₕ=UₕIₕ=Uₕ²/Rₕ=100²/1000=10Wt

### Consequently, EF=Pₕ/P_{g}≈10 Wt/10 Wt≈1.

Thus, unlike the known EPTD (Patent UA No. 78002), the operability and industrial applicability of the inventive EPTD is proven experimentally.

The effective operability of the inventive EPTD at replacement of the grounding with ‘counterbalances’ (‘counterbalances’ herein mean electro-conductive (e.g. metal) elements (e.g., plates) with a predetermined area, preferably of about 0.5 m², etc.) is also experimentally confirmed. The electric grounding functions of the counterbalances can be also carried out by an electro-conductive housing of the generator and an electro-conductive housing (body) of the load resistor, which is confirmed by experiments.

Methods of reduction of the resonant frequency, increase in power and distance of the wireless electric power transfer are theoretically developed.

### BIBLIOGRAPHY

1. Kriuk V. G., Iatsyshyn V. A, Beldii M. M. “Wireless electric power transmission device”. Patent UA No. 78002, Bulletin N22, 2007.
2. Meinhe H., Gundlakh F. V. “Radiotechnical reference book”, Vol. 1, M-L, “Gosenergoizdat”, 1961.
3. Vigodskiy M. Ya. “Calculus reference book”, M., “Nauka”, 1963.
4. Katushev A. M., Golubeva N. S C. “Basics of radioelectronics”, M., “Energiya”, 1969.
5. Sivuhin D. V, “General Physics Course”, Vol. III, M., “Nauka”, 1977.
6. Kriuk V. G., “Natural system of units on the base of units of natural time”, Kiev, “Hagar”, 2001.
7. Bronshtein N. N., Semendyaev K. A. “Mathematics reference book”, M., “Nauka”, 1964.

1. A device for wireless transmission of electric energy comprising:
(a) an electric power transmitter, including:
a transmitting antenna having a semi-pseudo-spherical shape with a coil wound thereon,
an electric power generator, serially connected with the transmitting antenna, and
a transmitter grounding, serially connected with the generator; and
(b) an electric power receiver, including:
a receiving antenna having a semi-pseudo-spherical shape with a coil wound thereon,
an electric load serially connected with the receiving antenna, and
a receiver grounding, serially connected with the electric load.

2. The device according to claim 1, wherein at least one of said transmitter grounding and said receiver grounding is embodied in the form of an electro-conductive element with a predetermined area.

3. The device according to claim 2, wherein
said generator includes an electro-conductive generator housing and/or said electric load includes an electro-conductive load housing, and
said electro-conductive element of the transmitter grounding is represented by the generator housing, or/and said electro-conductive element of the receiver grounding is represented by the load housing.

4. (canceled)
